(19) United States
(12) Patent Application Publication
(10) Pub. No.: US 2025/0086478 A1
(43) Pub. Date: Mar. 13, 2025

(54) IDENTIFICATION OF ELECTRONIC BOOKS FOR AUDIOBOOK PUBLICATION

(71) Applicant: Podium Publishing SubCo, LLC, El Segundo, CA (US)

(72) Inventors: Wyatt Millar, El Segundo, CA (US); Jon Oxidine, El Segundo, CA (US); Alyssa Buchthal, El Segundo, CA (US); Sridar Peyyeti, New York, NY (US); Ihor Yaroshenko, New York, NY (US); Mariia Havryliak, New York, NY (US); Galia Dychko, New York, NY (US); Mykola Steshenko, New York, NY (US); Mohit Devlani, Frisco, TX (US); Shubham Bhosale, Frisco, TX (US); Abishek Khandelwal, Frisco, TX (US); Chris Battaglino, Wallace, NC (US)

(21) Appl. No.: 18/367,198

(22) Filed: Sep. 12, 2023

(51) Int. Cl. G06N 5/022

(52) U.S. Cl. CPC G06N 5/022

(57) ABSTRACT

Technologies are provided for evaluation of electronic books as candidates for publication as audiobooks. An electronic book can be evaluated using a machine-learning model trained using target electronic books as a training set and various attributes of the target electronic books as feature inputs. A target electronic book is an electronic book that published prior to the publication of the electronic book as a successful audiobook. Success can be established using performance metrics, such as number of sales and/or review ratings, and a defined success rule. The various attributes include static attributes (author and genre, for example) and dynamic attributes representing respective performance metrics. By applying the trained machine-learning model to values of static and dynamic attributes of a particular electronic book, a candidacy score can be determined. The candidacy score represents a likelihood that the particular electronic book is a candidate for publication as an audiobook.

### SUMMARY

It is to be understood that both the following general description and the following detailed description are exemplary and explanatory only and are not restrictive.

In an embodiment, disclosed are computer-implemented methods comprising accessing book data defining values of attributes of multiple electronic books corresponding to multiple successful audiobooks: generating, using the book data, multiple features for a predictive model: training, using a portion of the second data and the multiple features, the predictive model to designate a particular electronic book as a candidate for audiobook publication or a non-candidate for audiobook publication: evaluating, using a second portion of the second data, the trained predictive model; and outputting, based on the evaluating, the trained predictive model.

In an embodiment, disclosed are computer-implemented methods comprising accessing book data identifying values of multiple features of an electronic book not having an audiobook counterpart, wherein the multiple features comprise static attributes of the electronic book and dynamic attributes of the electronic book: applying a predictive model to the book data; and determining, based on the applying, that the electronic book is a candidate for audiobook publication.

In an embodiment, disclosed are computing systems comprising at least one processor; and at least one memory device having computer-executable instructions stored thereon that, in response to execution by the at least one processor, cause the computing system at least to: access book data identifying values of multiple features of an electronic book not having an audiobook counterpart, wherein the multiple features comprise static attributes of the electronic book and dynamic attributes of the electronic book: apply a predictive model to the book data; and determine, based on the applying, that the electronic book is a candidate for audiobook publication.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of the present description serve to explain the principles of the methods and systems described herein:

FIG. 1 shows an example operating environment for identification of electronic books for audiobook publication:

FIG. 2 shows an example computing system:

FIG. 3 shows an example machine-learning system:

FIG. 4 shows an example machine-learning method:

FIG. 5 shows a block diagram of an example computing system:

FIG. 6 shows an example method; and

FIG. 7 shows an example method.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. Similarly, when values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

Embodiments of this disclosure include computing systems, computing devices, computer-implemented methods, and computer program products that, individually or in combination, can be used for identification of electronic books for audiobook publication. Such identification can be based on generation of prediction attributes according to a predictive model. The predictive model can be embodied on a machine-learning model trained using target electronic books as a training set and various attributes of the target electronic books as feature inputs. A target electronic book is an electronic book that published prior to the publication of the electronic book as a successful audiobook. Success can be established using performance metrics, such as number of sales and/or review ratings, and a defined success rule. The various attributes include static attributes (author and genre, for example) and dynamic attributes representing respective performance metrics. Examples of the performance metrics include review rating, sale amounts, sale revenues, or similar quantities.

By applying the trained machine-learning model to values of static and dynamic attributes of a particular electronic book, a prediction attribute can be determined. The A prediction attribute can include a score (referred to as candidacy score) that defines a probability of an electronic book yielding a successful audiobook. Thus, the candidacy score represents a strength assessment of the electronic book as a candidate for audiobook publication. A candidacy score that meets or exceeds a defined threshold value can identify an electronic book as a good candidate for audiobook publication.

Accordingly, a trained predictive model can have optimized parameters that can map the group of performance signals to select electronic books corresponding to successful audiobooks. As such, the trained predictive model can weigh the various static and dynamic attributes used as feature inputs in order to predict electronic books that would yield a successful audiobook.

A trained predictive model can be applied to performance signals for a particular electronic book in order to determine if the particular electronic book is a candidate for audiobook publication. The particular electronic book can be included in a catalog of a digital marketplace. The digital marketplace can be administered by a branded retailer or an entity that permits participation of disparate retailer within the digital marketplace.

Prediction attributes in accordance with this disclosure constitute a data signal that can be incorporated into dashboard applications or other typed of analytics applications.

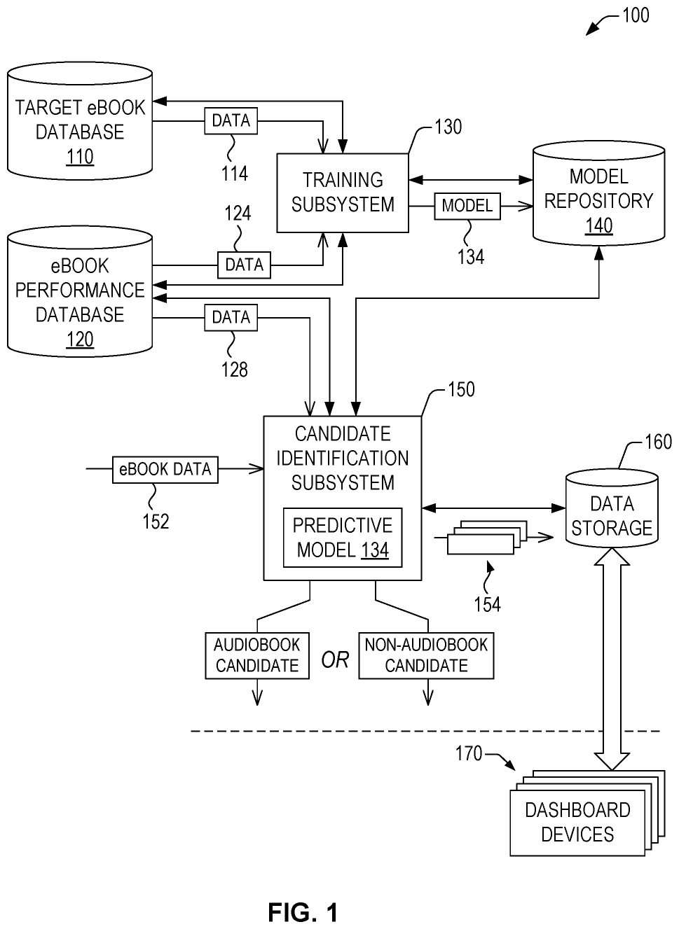

With reference to the drawings. FIG. 1 illustrates an example of an operating environment 100 for identification of electronic book candidates for audiobook publication, in accordance with one or more embodiments of this disclosure. The operating environment 100 includes a target ebook database 110 that retains data identifying electronic books having audiobook counterparts. Each one of the audiobook counterparts has one or multiple performance metrics having respective values meeting or exceeding a threshold value. An example of a performance metric is a number of units sold over a defined time interval since release date. In one example, the threshold value can be 5000 (audiobook units) and the defined time interval can be six months. In another example, the threshold value can be 3500) (audiobook units) and the defined time interval also can be sixth months. In some cases, instead of having a threshold value that is common to audiobooks across genres, a threshold value can be customized to a respective genre. Thus, audiobooks pertaining to a first genre (e.g., romance) can have a first threshold value associated therewith, and other audiobooks pertaining to a second genre (e.g., science fiction) can have a second threshold value associated therewith. A threshold value corresponding to that performance metric, regardless of the threshold value being customized according to genre, can be updated periodically or according to a defined schedule of updates. Another example of a performance metric includes reviews. For example, number of consecutive days having a threshold number of five-star reviews. For another example, upward or downward trend in the number of reviews having particular keywords or keyphrases over a defined period of time (e.g., a week, or a month). Such keywords and keyphrases can, individually or in combination, be indicative of audience sentiment towards an audiobook. Yet another example of a performance metric includes ratings. For example, the performance metric can be number of instances that an audiobook has been liked or number of instances that the audiobook has been disliked. As another example, the performance metric can be percentage of favorable ratings (e.g., likes, thumbs-ups, or similar) of a current total number of times that the audiobook has been rated over a period of time. As still another example, the performance metric can be a rate of increase of favorable ratings for an audiobook over a defined number of days. Such a rate of increase can be indicative of consumption momentum of the audiobook. As a still further example, the performance metric can be number of recommendations of an audiobook in social media or another type of communication platform. Regardless of performance metric and the manner of configuring a threshold value, audiobook counterparts that exceed the threshold value can be referred to as successful audiobooks (or satisfactory audiobooks).

Electronic books also published as successful audiobooks can serve as a reference for other electronic books for which a determination regarding whether or not publication as audiobook is appropriate has yet to be made. Electronic books that have respective successful audiobooks can be referred to as target ebooks.

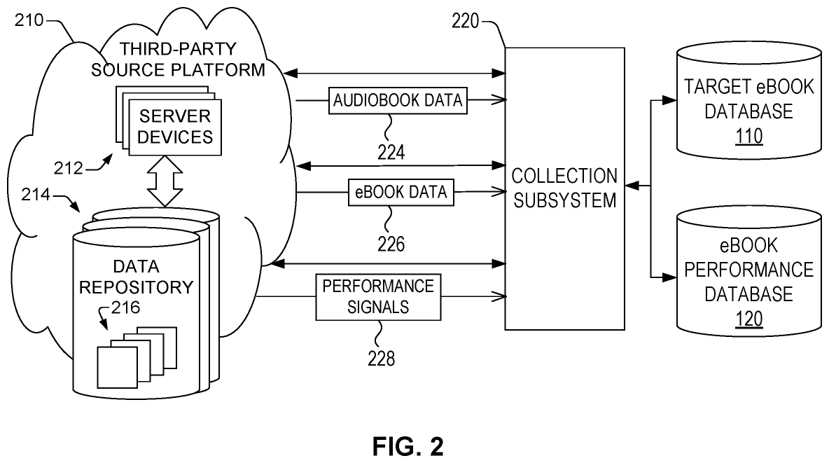

The data contained in the target ebook database 110 can originate from a third-party source platform 210, as is shown in FIG. 2. The third-party source platform 210 can provide a digital-book information service (data, intelligence, knowledge, or a combination thereof, for example) and can include one or multiple book-sales data repositories. Accordingly, the third-party source platform 210 can include various types of devices, including server devices 212 and multiple data repositories 214. One or more of the multiple data repositories 214 can embody, or can include, respective book-sales data repositories. A particular combination of the multiple server devices 212 and the multiple data repositories 214 can constitutes a digital book database. At least one of the multiple data repositories 214 can include digital book records that can be arranged, for example, in multiple tables 216. Thus, such a digital book database can include one or several of the multiple tables 216.

It is noted that other types of third-party source platforms also can be leveraged. For example, a social networking platform can be leveraged to obtain review ratings and sentiment data in connection with audiobooks and electronic books.

In some embodiments, the operating environment 100 can include a collection subsystem 220 (FIG. 2) functionally coupled to third-party source platform 210. The collection subsystem 220 can obtain audiobook data 224 defining a group of particular audiobooks. As is described herein, the particular audiobooks can be successful audiobooks. The disclosure, however, is not limited in that respect and different types of lists of audiobooks can be considered for the generation of predictive models. For instance, a group of particular audiobooks can include audiobooks in a particular genre (self-help, gardening, chords music, or true crime, for example).

To obtain the audiobook data 224, the collection subsystem 220 can inquiry one or more digital book databases within the third-party source platform 210. As mentioned, success of an audiobook can be gauged by the number of units sold during a defined period immediately subsequent to the release date of the audiobook. Thus, the inquiry can be based on a query for audiobook records that satisfy a defined date criterion. One or more of the server devices 212 can resolve the query and, as a result, can send the audiobook data 224 to the collection subsystem 220. The audiobook data 224 can be sent via a gateway device and a communication network.

The collection subsystem 220 can operate on the audiobook data 224 to remove at least one audiobook from the group of audiobooks according to one or more filter rules. In some example scenarios, multiple filter rules are applied. One rule of the multiple filter rules dictates that an audiobook having a publication date earlier than a cutoff date is to be removed. Another rule of the multiple filter rules dictates that an audiobook lacking historical sales data over a defined time interval is to be removed. Examples of the defined time interval include one month, three months, six months, and one year. Yet another rule of the multiple filter rules dictates that an audiobook having a publisher identifier (ID) that is a repeated (e.g., the ID is a duplicate) within the group of audiobooks is to be removed from the group.

Removal of one or more audiobooks from the group of audiobooks as is described above results in a filtered group of audiobooks, which is a pared down version of the group of audiobooks. The collection subsystem 220 can further operate on the filtered group of audiobooks to detect one or more successful audiobooks within the filtered group of audiobooks. To that end, the collection subsystem 220 can iteratively determine whether or not each audiobook in the filtered group of audiobooks satisfies a success criterion (e.g., a number of units sold being equal to or greater than a threshold number). Hence, the collection subsystem 220 can iteratively update a group of successful audiobooks by adding a successful audiobook to that group while traversing the filtered group of audiobooks.

The collection subsystem 220 can use the group of successful audiobooks to obtain ebook data 226 defining a group of target ebooks. Because a successful audiobook may not have an electronic book counterpart, the collection subsystem 220 can determine a retailer product ID for each successful audiobook in the group of successful audiobooks that has an electronic book counterpart. The retailer product ID can be a unique identifier for a product within a catalog of a digital marketplace. As a result, the collection subsystem 220 can generate a list of retailer product IDs for respective electronic books, each corresponding to a successful audiobook.

The collection subsystem 220 can operate on the list of retailer product IDs in order to generate a list of unique IDs for respective electronic books. Operating on the list of retailer product IDs can include applying multiple filter rules. One rule of the multiple filter rules dictates that an electronic book corresponding to multiple retailer product IDs is to be removed. Accordingly, the multiple retailer product IDs also are removed. To further avoid redundancy in the list of retailer product IDs, a particular retailer ID that is associated with two or more successful audiobooks can be removed from the list. By generating a list of unique IDs, redundant samples can be avoided in the training of a model (e.g., model 134) by the training subsystem 130. In addition, or in some example scenarios, having such a list of unique IDs can avoid causing presentation (at a dashboard device of dashboard devices 170, for example) of an electronic book for which an audiobook already exists.

For each item in the list of unique IDs for respective electronic books, the collection subsystem 220 can inquiry one or more digital book databases within the third-party source platform 210. The inquiry can be based on a query for ebook records that satisfy a defined date criterion, e.g., the electronic book defined by an ebook record must have a publication date that is earlier than the publication date of the audiobook counterpart. One or more of the server devices 212 can resolve the query and, as a result, can send the ebook data 226 to the collection subsystem 220. The ebook data 226 can be sent via a gateway device and a communication network. The ebook data 226 can define ebook records that include static attributes for each electronic book identified by a respective ebook record of the ebook records. The static attributes for an electronic book can include title, author information (e.g., author name), genre, book length, story dynamics, character information (e.g., number or characters, type of characters), plot direction, and combination thereof, or similar attributes, for example. Each ebook record can include static attributes for an electronic book, where the static attributes can pertain to a particular period immediately subsequent to publication date of the electronic book. The particular period can be 50 days, for example. The collection subsystem 220 can retain the ebook data 226 within a target ebook database 110 (FIG. 1).

With further reference to FIG. 1, the operating environment 100 also includes an ebook performance database 120 that contains data characterizing performance metrics for target ebooks. A performance metric can be referred to as a dynamic attribute of an electronic book (target ebook or otherwise). The performance metrics can include, for example, number of sales over a defined time period, sale revenue, price point, review rating, a combination thereof, or similar metrics. It is noted that the embodiments of this disclosure need not rely exclusively on the foregoing performance metrics. Data defining values of a performance metric constitute a performance signal. As mentioned, the performance metric is specific to an electronic book (target ebook or otherwise).

The collection subsystem 220 (FIG. 2) also can obtain performance signals 228 from the third-party source devices 210. The performance signals 228 can be acquired periodically or according to another type of schedule. As a result, the performance data retained in the ebook performance database 120 is updated accordingly.

For each ebook record available in the target ebook database 110, the collection subsystem 220 can obtain data 228 defining values of performance metrics corresponding to the electronic book identified by the ebook record. To that end, the collection subsystem 220 can inquiry one or more digital book databases within the third-party source platform 210 for sales data and/or sales statistics for the electronic book identified by the ebook record.

Back to referring to FIG. 1, a group of defined performance signals for defined target ebooks can be used to generate a predictive model to determine a probability that a an electronic book would be a candidate for audiobook publication (or audiobook candidate) according to the defined target ebooks. In other words, the predictive model can determine the likelihood that an electronic book can yield a successful audiobook. The probability determined by the predictive model defines a candidacy score Si that represents an assessment of likely success of an electronic book when published as an audiobook. The score SE can have a value in the range from 0 to 1. The larger the value of the likely-success score Sp, the higher the likelihood of an electronic book to be a successful audiobook.

To generate such a predictive model, the operating environment 100 also includes a training subsystem 130 that can generate a machine-learning (ML) model using multiple feature inputs, each feature input corresponding to either a static attribute or a performance signal corresponding to a dynamic attribute. The ML model embodies the predictive model. In some embodiments, generating the ML model includes training a classification model using a group of target ebooks as a training set and the multiple feature inputs for the group of target ebooks. The classification model that solves a binary classification task. In addition, or in other embodiments, generating the ML model includes training a regression model using the group of target ebooks as a training set and the multiple feature inputs for the group of target ebooks.

The training subsystem 130 can receive data 114 identifying the group of target ebooks from the target ebook database 110. The training subsystem 130 can generate, using the data 114, each one of static attributes for electronic books in the group of target books. The training subsystem 130 also can receive data 124 defining each one of dynamic attributes for electronic books in the group of target ebooks. The data 124 can be received from the ebook performance database 120. Using the static attributes and dynamic attributes for the group of target ebooks, the training subsystem 130 can determine a solution to an optimization problem with respect to a prediction error function. The prediction error function is based on results yielded by a current predictive model being trained and available training data, and determines a difference between a prediction of the current predictive model and a corresponding known value or outcome from the training data. The solution can be determined iteratively, in some cases. Regardless of how the solution is determined, the solution results in model parameters that minimize the prediction error function. The model parameters define a trained predictive model 134. The training subsystem 130 can output the trained predictive model 134. Outputting the trained predictive model 134 can include retaining such model parameters in one or more memory devices 140 (generically referred to as model repository 140).

The operating environment 100 also includes a candidate identification subsystem 150 that can access the predictive model 134 from the model repository 140 and can retain the predictive model 134 in one or more memory devices (not depicted in FIG. 1). In some configurations, the trained predictive model 134 can be accessed directly from the model repository 140. In other configurations, the trained predictive model 134 can be accessed by means of an API or another type of program code. The API or that program code can be provided by the training subsystem 130 or another component (not depicted in FIG. 1) functionally coupled to the training subsystem 130 and/or the model repository 140.

The candidate identification subsystem 150 also can include a prediction module (not depicted in FIG. 1) that can generate a prediction attribute for a particular electronic book by applying the predictive model 134 to multiple defined features of the particular electronic book. The particular electronic book does not have an audiobook counterpart. The particular electronic book can be extant ebook within a catalog available to platform that administers or uses the candidate identification subsystem 150. In some cases, the particular electronic book may be a new addition to that catalog. The particular electronic book can be identified by a dataset within ebook data 152 that can be obtained by the candidate identification subsystem 150. The ebook data 152 can include multiple datasets identifying respective particular electronic books.

As mentioned, the multiple defined features include a combination of static attributes and dynamic attributes. The prediction attribute can designate the particular electronic book as one of audiobook-candidate or non-audiobook-candidate. The prediction attribute can be embodied in, or can include, a label. For purposes of illustration, the label can contain a string of characters that convey that the particular electronic book is either an audiobook-candidate or a non-audiobook-candidate. Indeed, in one example, the label can be one of “Audiobook Candidate” or “Non-Audiobook Candidate.” In other examples, the label can include one or a combination of another type of textual element, a graphical element, or an aural element conveying that the particular electronic book is one of an audiobook-candidate or a non-audiobook-candidate.

In addition, the prediction module can generate a confidence score for a label that has been generated. The confidence score can be generated concurrently with the generation of the label, in response to the application of the predictive model 134 to the multiple defined features of the particular electronic book. The confidence score can be a real number in the interval [0.1] and represents a probability of the label being accurate.

The candidate identification subsystem 150 can evaluate a group of multiple electronic books to identify candidates for audiobook publication. To that end, the candidate identification subsystem 150 can generate respective prediction attributes 154 for the multiple electronic books in the group. Electronic books for which performance signals are available within the ebook performance database 120 constitute the group of multiple electronic books. Such performance signals are the same type of performance signals used as feature inputs in the training of the predictive model 134. As such, the candidate identification subsystem 150 can access performance data 128 defining performance signals for the group of multiple electronic books. The performance signals defined by the performance data 128 can include dynamic attributes of the group of multiple electronic books. As mentioned, the dynamic attributes can include, for example, number of sales over a defined time period, sale revenue, price point, review rating, or similar.

The candidate identification subsystem 150 can then generate the respective prediction attributes 154 for the group of multiple electronic ebooks by applying the trained predictive model 134 to the static attributes and performance data 128. The prediction attributes 154 can include, or can embody, candidacy scores. Each candidacy score can have a magnitude in a range from 0 to 1. A candidacy score that is equal to 0 indicates a non-candidate for audiobook publication, and a candidacy score equal to 1 indicates a candidate for audiobook publication. That is, a candidacy score that is equal to 0 denotes an electronic book that would yield an unsuccessful audiobook and, thus, it would be excluded from publication as an audiobook. A candidacy score that is equal to 1 denotes an electronic book that would yield a successful audiobook and, thus, it is a candidate for publication as an audiobook. A candidacy score that exceeds a defined threshold (e.g., 0.7, 0.8, or 0.9) can denote an electronic book that is likely to yield a successful audiobook.

The candidate identification system 150 can supply prediction attributes 154 that have been generated. In some configurations, the prediction attributes 154 can be supplied in response to being generated regardless of magnitude (or a value) of the prediction attributes 154. Supplying the prediction attributes 154 can include outputting the prediction attribute to data storage 160 functionally coupled to the candidate identification subsystem 150. Additionally, or in some embodiments, supplying the prediction attributes also can include configuring an interface (e.g., an API: not depicted in FIG. 1) to permit access to the retained prediction attribute(s).

Further, or in some embodiments, the candidate identification subsystem 150 can supply the prediction attributes 154 by causing a display device (not depicted in FIG. 1) to present a visual element indicative of the prediction attribute (e.g., “Audiobook Candidate” or “Non-Audiobook Candidate”). The display device can be external to an architecture that includes the candidate identification subsystem 150. A dashed line in FIG. 1 schematically depicts a boundary between such an architecture and a platform that can include the display device.

The visual element can be color-coded according to the prediction attribute. For example, in cases where the prediction attribute includes a confidence score or another numeric predication within a defined interval, a color of the visual element can convey a magnitude of the confidence score of the numeric prediction. A first color (e.g., blue) can correspond to confidence score equal to 1 and a second color (e.g., red) can correspond to a confidence score equal to zero. The visual element can have colors within the gamut of colors between the second color and the first color for values of the confidence score between zero and 1.

In other configurations, the candidate identification subsystem 150 can determine if a prediction attribute satisfies a lead criterion. For example, in cases where the prediction attribute is embodied in a label, the lead criterion can dictate that reporting occurs when a confidence score generated for the label meets or exceeds a threshold value (e.g., a real number in the interval [0,1]). In response to a determination that the prediction attribute satisfies the lead criterion, the candidate identification subsystem 150 can supply the prediction attribute by retaining one or both of those attributes in data storage 160, and configuring an interface (e.g., an API: not depicted in FIG. 1) to permit access to the retained prediction attribute(s).

In addition, or as an alternative response to such a determination, the candidate identification subsystem 150 can supply the prediction attribute by sending the prediction attribute to one or more devices (e.g., a server device, a terminal device, a display device: not depicted in FIG. 1). At least one of such device(s) can be remotely located relative to the candidate identification subsystem 150. In some cases, the prediction attribute can be sent in essentially real-time, as the prediction attribute is generated or otherwise becomes available.

At least a subset of the prediction attributes 154 can be utilized in an analytics platform that can use the likelihood that an electronic book would yield a successful audiobook as a parameter for allocation of computing resources and/or decision making. The analytics platform can be external to the architecture that includes the candidate identification subsystem 150. The dashed line in FIG. 1 schematically depicts a boundary between such an architecture and the analytics platform.

The analytics platform can include one or multiple dashboard devices 170 remotely located relative to the data storage 160 and the candidate identification subsystem 150. In some cases, each one of the dashboard device(s) 170 is a computing device that includes computing resources (e.g., one or more processors, one or more memory devices, software, firmware, network interfaces, and similar resources) and has a display device integrated therein or functionally coupled thereto. At least one of the dashboard devices 170 can access the data storage 160 to obtain prediction attributes. At least one of the dashboard devices 170 can execute analytics software to assess various aspects of paper books, electronic books, and audiobooks. The data storage 160 can be accessed via an interface device (e.g., an API server: not depicted in FIG. 1) within the architecture. To that end, a dashboard device of the dashboard devices 170 execute a function call of an API provisioned by the interface device. The API permits access to the data storage 160, for example. In response, the interface device can send the subset of the prediction attributes 154 to the at least one of the dashboard devices 170.

One or more of the prediction attributes 154 can be accessed in numerous other ways, in addition or an alternative to accessing prediction attribute(s) from the data storage 160. For example, at least one of the dashboard devices 170 can request one or several prediction attributes from the candidate identification subsystem 150. That is, the candidate identification subsystem 150 can generate a prediction attribute in response to a request from the at least one of the dashboard devices 170. The prediction attribute(s) can be requested by executing a function call of an API. The API can be provided by candidate identification subsystem 150 or the interface device that provides the API to access the data storage 160.

The predictive models disclosed herein need not be static. The third-party source platform that sources the data retained in the ebook performance database 120 can be updated routinely for a defined group of target ebooks. Therefore, the data 124 used to generate a predictive model can be updated accordingly, even when the training set formed by the group of target ebooks remains the same. That is, because dynamic attributes of electronic ebooks can change over time, training data used to generate a predictive model also can change over time. The training subsystem 130 can then generate an updated version of the trained predictive model 134 using updated instances of the data 124. Thus, prediction attributes for particular electronic books also can be updated routinely in order to reflect up-to-date opinions of readers of the particular electronic books.

In an embodiment, a predictive model (e.g., a machine-learning classifier) may be generated to classify an electronic book as a candidate for publication as an audiobook or a non-candidate for publication as an audiobook based on analyzing book data corresponding to electronic books that have been published as audiobooks. The predictive model may be trained according to data defining values of static attributes and dynamic attributes for multiple select electronic books. The select electronic books correspond to respective successful audiobooks.

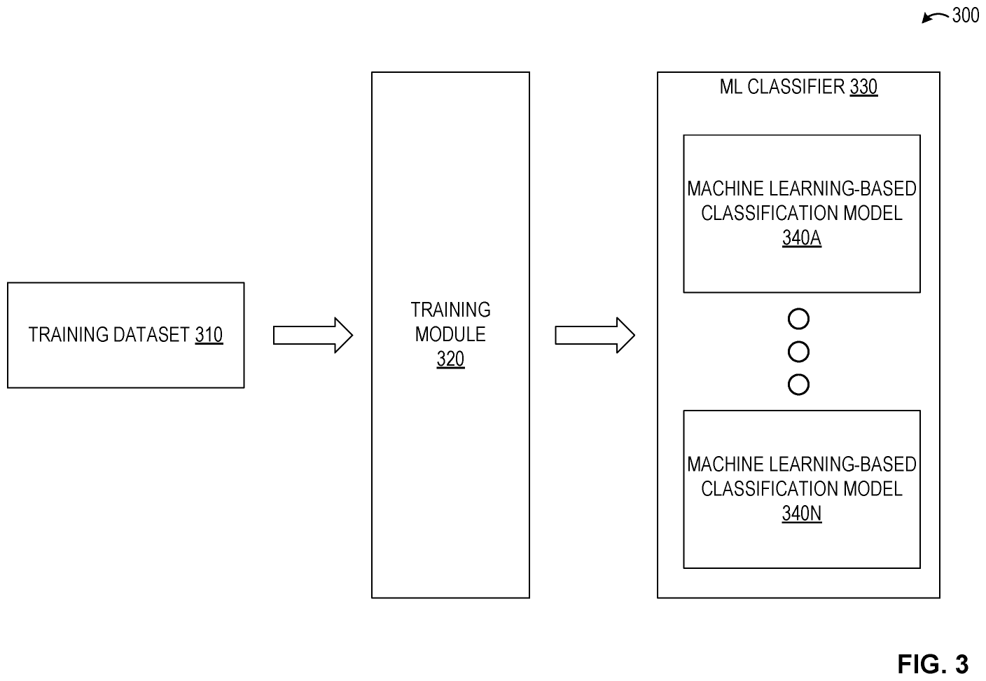

As is shown in FIG. 3, a system 300 is described herein that is configured to use machine-learning techniques to train, based on an analysis of one or more training data sets by a training module 320, at least one machine learning-based classifier 330. The training module 320 can be a part of the training subsystem 130 (FIG. 1). The training datasets can include a training dataset 310. Each of the at least one machine learning-based classifier 330 is configured to classify book data corresponding to electronic books as pertaining to a category of electronic books that are candidates for publication as audiobooks or another category of electronic books that are non-candidates for publication as audiobooks. In an embodiment, the training dataset 310 may comprise data defining values of static attributes and dynamic attributes for multiple select electronic books.

The training dataset 310 can be randomly partitioned into a first subset used for training or a second subset used for evaluation purposes. In general, any suitable method may be used to assign training data to the first subset or the second subset. In an embodiment, 75% of the select electronic books may be assigned to the first subset of the training dataset 310 and 25% of such electronic books may be assigned to the second subset used for evaluation purposes.

In an embodiment, the training module 320 may train the machine learning-based classifier 330 by extracting a feature set from book data within the training dataset 310 according to one or more feature selection techniques.

In an embodiment, the training module 320 may extract a feature set from the training dataset 310 in a variety of ways. The training module 320 may perform feature extraction multiple times, each time using a different feature-extraction technique. In an embodiment, the feature sets generated using the different techniques may each be used to generate different machine learning-based classification models 340. In an embodiment, the feature set with the highest quality metrics may be selected for use in training. The training module 320 may use the feature set(s) to generate one or more machine learning-based classification models 340A-340N that are configured to indicate whether or not book data corresponding to a particular electronic book pertain to a audiobook-candidate category.

The term “feature,” as used herein, may refer to any characteristic of an item of data that may be used to determine whether the item of data falls within one or more specific categories. As an example, the features described herein may comprise static attributes and/or dynamic attributes of an electronic book. As mentioned, the static attributes can include title, author name, genre, book length, story dynamics, character information (e.g., number or characters, type of characters), plot direction, a combination thereof, or similar attributes, for example. The dynamic attributes can include number of sales over a defined time period, sale revenue, price point, review rating, a combination thereof, or similar metrics, for example.

In an embodiment, a feature selection technique may comprise one or more feature selection rules. In an embodiment, a single feature selection rule may be applied to select features or multiple feature selection rules may be applied to select features.

A resulting list of dynamic attributes may be analyzed according to additional feature selection techniques to determine one or more dynamic attributes of electronic books (e.g., one or more of the features that may be used to predict whether a particular electronic book is a candidate for audiobook publication or a non-candidate for audiobook publication). Any suitable computational technique may be used to identify the dynamic attributes using any feature selection technique such as filter, wrapper, and/or embedded methods. In an embodiment, one or more dynamic attributes may be selected according to a filter method. Filter methods include, for example. Pearson's correlation, linear discriminant analysis, analysis of variance (ANOVA), chi-square, combinations thereof, and the like. The selection of features according to filter methods are independent of any machine learning algorithms. Instead, features may be selected on the basis of scores in various statistical tests for their correlation with the outcome variable (e.g., candidate/non-candidate).

In an embodiment, one or more dynamic attributes of electronic books may be selected according to a wrapper method. A wrapper method may be configured to use a subset of features and train a machine learning model using the subset of features. Based on the inferences that have been drawn from a previous model, features may be added and/or deleted from the subset. Wrapper methods include, for example, forward feature selection, backward feature elimination, recursive feature elimination, combinations thereof, and the like. In an embodiment, forward feature selection may be used to identify one or more dynamic attributes of electronic books. Forward feature selection is an iterative method that begins with no feature in the machine-learning model. In each iteration, the feature which best improves the machine-learning model is added until an addition of a new variable does not improve the performance of the machine-learning model. In an embodiment, backward elimination may be used to identify one or more dynamic attributes of electronic books. Backward elimination is an iterative method that begins with all features in the machine-learning model. In each iteration, the least significant feature is removed until no improvement is observed on removal of features. In an embodiment, recursive feature elimination may be used to identify one or more dynamic attributes of electronic books. Recursive feature elimination is a greedy optimization algorithm which aims to find the best performing feature subset. Recursive feature elimination repeatedly creates models and keeps aside the best or the worst performing feature at each iteration. Recursive feature elimination constructs the next model with the features remaining until all the features are exhausted. Recursive feature elimination then ranks the features based on the order of their elimination.

In an embodiment, one or more dynamic attributes of electronic books may be selected according to an embedded method. Embedded methods combine the qualities of filter and wrapper methods. Embedded methods include, for example. Least Absolute Shrinkage and Selection Operator (LASSO) and ridge regression which implement penalization functions to reduce overfitting. For example LASSO regression performs L1 regularization which adds a penalty equivalent to absolute value of the magnitude of coefficients and ridge regression performs L2 regularization which adds a penalty equivalent to square of the magnitude of coefficients.

After the training module 320 has generated a feature set(s), the training module 320 may generate a machine learning-based classification model 340 based on the feature set(s). Machine learning-based classification model, may refer to a complex mathematical model for data classification that is generated using machine-learning techniques. In one example, this machine learning-based classifier may include a map of support vectors that represent boundary features. By way of example, boundary features may be selected from, and/or represent the highest-ranked features in, a feature set.

In an embodiment, the training module 320 may use the feature sets extracted from the training dataset 310 to generate a machine learning-based classification model 340A-340N for each classification category (e.g., candidate for audiobook publication, non-candidate for audiobook publication). In some examples, the machine learning-based classification models 340A-340N may be combined into a single machine learning-based classification model 340. Similarly, the machine learning-based classifier 330 may represent a single classifier containing a single or a plurality of machine learning-based classification models 340 and/or multiple classifiers containing a single or a plurality of machine learning-based classification models 340.

The extracted features may be combined in a classification model trained using a machine-learning approach such as discriminant analysis: decision tree: a nearest neighbor (NN) algorithm (e.g., k-NN models, replicator NN models, etc.); statistical algorithm (e.g., Bayesian networks, etc.): clustering algorithm (e.g., k-means, mean-shift, etc.); neural networks (e.g., reservoir networks, artificial neural networks, etc.): support vector machines (SVMs): logistic regression algorithms: linear regression algorithms: Markov models or chains: principal component analysis (PCA) (e.g., for linear models): multi-layer perceptron (MLP) ANNs (e.g., for non-linear models): replicating reservoir networks (e.g., for non-linear models, typically for time series); random forest classification: a combination thereof and/or the like. The resulting machine learning-based classifier 230 may comprise a decision rule or a mapping that uses the static attributes or the dynamic attributes, or a combination thereof, corresponding to an electronic book in order to assign the electronic book to a particular category (e.g., candidate for audiobook publication or non-candidate for audiobook publication).

The machine learning-based classifier 230 may be used to predict the candidate/non-candidate statuses of the select electronic books within the second subset of the training dataset, where, as mentioned, such second subset is used for evaluation purposes. In one example, the result for each electronic book includes a confidence level that corresponds to a probability that the corresponding electronic book belongs in the predicted responder/non-responder status. The confidence level may be a value between zero and one, where the value represents a likelihood that the corresponding test sample belongs to a candidate/non-candidate status. In one example, when there are two statuses—e.g., candidate for audiobook publication and non-candidate for audiobook publication—the confidence level may correspond to a value p, which refers to a probability that a particular electronic book belongs to the first status (e.g., candidate for audiobook publication). In this case, the value 1-p may refer to a probability that the particular electronic book belongs to the second status (e.g., non-candidate for audiobook publication). In general, multiple confidence levels may be provided for each electronic book when there are more than two statuses.

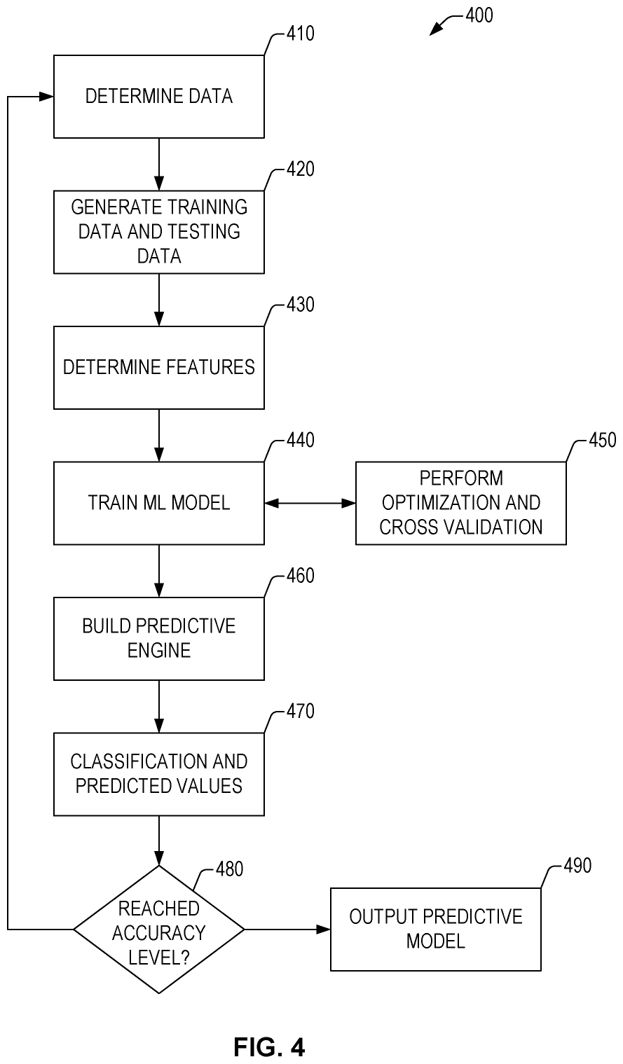

FIG. 4 is a flowchart illustrating an example training method 400 for generating the machine learning-based classifier 330 using the training module 320. The training module 320 can implement supervised, unsupervised, and/or semi-supervised (e.g., reinforcement based) machine learning-based classification models 340. The example training method 400 illustrated in FIG. 4 is an example of a supervised learning method. Variations of this example of training method are discussed below, however, other training methods can be analogously implemented to train unsupervised and/or semi-supervised machine learning models.

The example training method 400 may determine (e.g., access, receive, retrieve, etc.) book data corresponding to a group of multiple select electronic books at block 410. The book data includes book datasets for respective select electronic books of the group of multiple select electronic books. Each book dataset can include values of static attributes of a select electronic book and values of dynamic attributes of the select electronic book.

The example training method 400 may generate, at block 420, training data and testing data (also referred to as evaluation data). The training data set and the testing data set may be generated by randomly assigning book datasets of individual select electronic books to either the training data or the testing data. In some implementations, the assignment of select electronic books as training or test samples may not be completely random. In an embodiment, a majority of the book datasets that constitute the book data may be used to generate the training data. For example 75% of the book datasets may be used to generate the training data set and 25% may be used to generate the testing data.

The example training method 400 may determine (e.g., extract, select, etc.), at block 430, one or more features that can be used by, for example, a classifier to differentiate among different classifications (e.g., candidate for audiobook publication vs. non-candidate for audiobook publication). As mentioned, the one or more features may comprise static attributes or dynamic attributes, or a combination of both, corresponding to electronic books. In an embodiment, the example training method 400 may determine a set of features from book data available in the target ebook database 110 (FIG. 1) and/or the ebook performance database 120 (FIG. 1).

The example training method 400 may train one or more machine learning models using the one or more features at block 440. In one embodiment, the machine learning models may be trained using supervised learning. In another embodiment, other machine learning techniques may be employed, including unsupervised learning and semi-supervised. The machine learning models trained at block 440 may be selected based on different criteria depending on the problem to be solved and/or data available in the training data set. For example, machine learning classifiers can suffer from different degrees of bias. Accordingly, more than one machine learning models can be trained at 440, optimized, improved, and cross-validated at block 450.

The example training method 400 may select one or more machine learning models to generate a predictive model at block 460 (e.g., a machine learning classifier). The predictive model may be evaluated using the testing data set. The predictive model may analyze the testing data set and generate classification values and/or predicted values at block 470. Classification and/or prediction attributes may be evaluated at block 480 to determine whether such attributes have achieved a desired accuracy level.

Performance of the predictive model may be evaluated in a number of ways based on a number of true positives, false positives, true negatives, and/or false negatives classifications of the plurality of data points indicated by the predictive model. For example, the false positives of the predictive model may refer to a number of times the predictive model incorrectly classified an electronic book as a candidate for audiobook publication that was, in reality, a non-candidate for audiobook publication. Conversely, the false negatives of the predictive model may refer to a number of times the predictive model classified one or more electronic books as a non-candidate for audiobook publication when, in fact, the electronic book was a candidate for audiobook publication. True negatives and true positives may refer to a number of times the predictive model correctly classified one or more electronic books as a candidate for audiobook publication or a non-candidate for audiobook publication. Related to these measurements are the concepts of recall and precision. Generally, recall refers to a ratio of true positives to a sum of true positives and false negatives, which quantifies a sensitivity of the predictive model. Similarly, precision refers to a ratio of true positives to a sum of true and false positives.

When such a desired accuracy level is reached, the training phase ends and the predictive model may be output at block 490. When the desired accuracy level is not reached, however, then a subsequent iteration of the example training method 400 may be performed starting at block 410 with variations such as, for example, considering a larger collection of electronic books and associated book data.

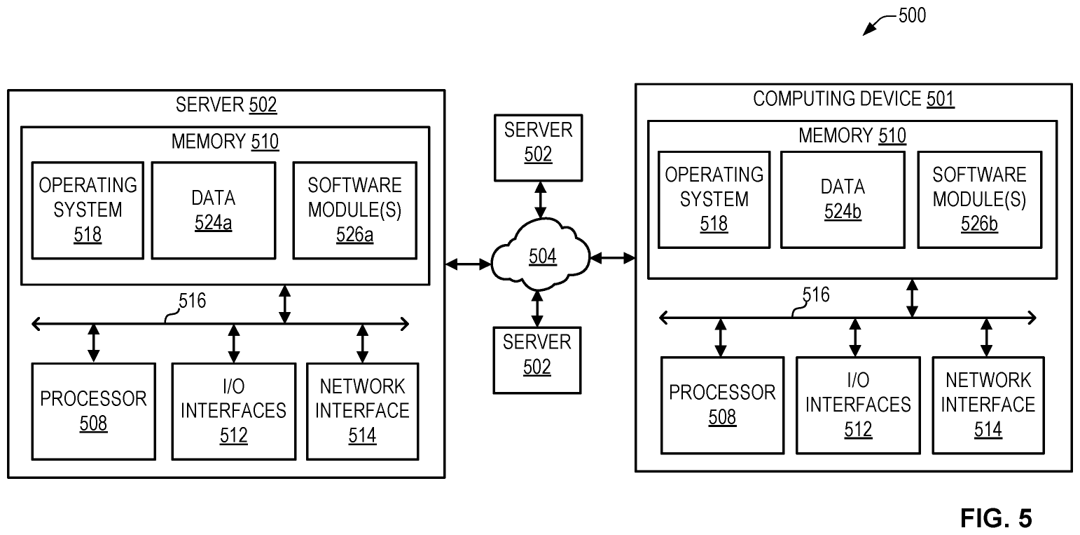

FIG. 5 is a block diagram depicting a computing system 500 comprising non-limiting examples of a computing device 501 and a server 502 functionally coupled via a network 504. In an aspect, some or all operations of any described method may be performed on a computing device or a server device (also referred to as server), or a combination of both, as described herein. The computing device 501 can comprise one or multiple memory devices 510 (generically referred to as memory 510) configured to store, among other things, data 524b, one or more software modules 526b, and a suitable operating system (O/S) 518. The server 502 can comprise memory 510 configured to store, among other things, data 524b, one or more software modules 526b, and a suitable O/S 518. Multiple servers 502 can communicate with the computing device 501 via the network 504.

The computing device 501 and the server 502 can be a digital computer that, in terms of hardware architecture, generally includes a processor 508, memory 510, input/output (I/O) interfaces 512, and network interfaces 514. These components (508, 510, 512, and 514) are communicatively coupled via a local interface 516. The local interface 516 can be, for example, one or more buses or other wired or wireless connections. The local interface 516 can have additional elements, which are omitted for simplicity, such as controllers, buffers (caches), drivers, repeaters, and receivers, to enable communications. Further, the local interface 516 may include address, control, and/or data connections to enable appropriate communications among the aforementioned components.

The processor 508 can be a hardware device for executing software, particularly that stored in memory 510. The processor 508 can be any custom made or commercially available processor, a central processing unit (CPU), an auxiliary processor among several processors associated with the computing device 501 and the server 502, a semiconductor-based microprocessor (in the form of a microchip or chipset), or generally any device for executing program code and/or other types of processor-accessible instructions. When the computing device 501 and/or the server 502 is in operation, the processor 508 can be configured to execute software stored within the memory system 510, to communicate data to and from the memory 510, and to generally control operations of the computing device 501 and the server 502 pursuant to the software. As is illustrated in FIG. 5, in the computing device 501, the software can include one or more software modules 536b, and in the server 502, the software can include one or more software modules 526a. In some configurations, the software module(s) 526a, in response to being executed by the processor 508 within the server 502, can provide the functionality of the training subsystem 130 as described herein. Indeed, one or a combination of the server 502 included in the computing system 500 can embody the training subsystem 130 (FIG. 1). As mentioned, the memory 510 within the server 502 also can include data 524a that can be operated upon by the software module(s) 526a as part of providing the functionality of the training subsystem 130. The data 524a can include book data. In some cases, the book data can include at least a portion of the data contained in the target ebook database 110 (FIG. 1) and the ebook performance database 120 (FIG. 1). It is noted that another one or more of the server 502 can embody storage server device(s) that can contain the target ebook database 110 and the ebook performance database 120. Additionally, in such configurations, the software module(s) 526 (b), in response to being executed by the processor 508 within the computing device 501, can provide the functionality of the candidate identification subsystem 150 (FIG. 1) as described herein. Indeed, the computing device 501 can embody, or can constitute, the candidate identification subsystem 150. As such, the data 524b can include the predictive model 134 and, in some cases, the ebook data 152. One or more of the server 502 illustrated in FIG. 5 can embody storage service devices that form the data storage 160 (FIG. 1).

The I/O interfaces 512 can be used to receive user input from, and/or for providing system output to, one or more devices or components. User input can be provided via, for example, a keyboard, a mouse, and/or a touch-screen display device (not depicted in FIG. 5) integrated into the computing device or functionally coupled thereto. System output can be provided via a display device and a printer (not shown in FIG. 5). The I/O interfaces 512 can include, for example, a serial port, a parallel port, a Small Computer System Interface (SCSI), an infrared (IR) interface, a radio frequency (RF) interface, and/or a universal serial bus (USB) interface.

The network interface 514 can be used to transmit and receive from the computing device 501 and/or the server 502 over the network 504. The network interface 514 may include, for example, a 10BaseT Ethernet Adaptor, a 100BaseT Ethernet Adaptor, a LAN PHY Ethernet Adaptor, a Token Ring Adaptor, a wireless network adapter (e.g., WiFi, cellular, satellite), or any other suitable network interface device. The network interface 514 may include address, control, and/or data connections to enable appropriate communications on the network 504.

The memory 510 can include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the memory 510 may incorporate electronic, magnetic, optical, and/or other types of storage media. Note that the memory 510 can have a distributed architecture, where various components are situated remote from one another, but can be accessed by the processor 508.

The software in memory 510 may include one or more software programs, each of which comprises an ordered listing of executable instructions for implementing logical functions. As is shown in FIG. 5, the software in the memory 510 of the computing device 501 can comprise the software module(s) 526b, and the suitable O/S 518. Additionally, the software in the memory 510 of the server 502 can comprise the software module(s) 526a and the suitable O/S 518. The operating system 518 in both the computing device 501 and the server 502 essentially controls the execution of other computer programs and provides scheduling, input-output control, file and data management, memory management, and communication control and related services.

For purposes of illustration, application programs and other executable program components, such as the operating system 518, are illustrated herein as discrete blocks, although it is recognized that such programs and components can reside at various times in different storage components of the computing device 501 and/or the server 502. Respective implementations of the software module(s) 526a and the software module 526b can be stored on or transmitted across some form of computer readable media. Any of the methods disclosed herein can be performed by computer-executable instructions encoded or otherwise stored on computer-readable media. Computer-readable media can be any available media that can be accessed by a computer. As an example, computer-readable media can comprise “computer storage media” and “communications media.” “Computer storage media” can comprise volatile and non-volatile, removable and non-removable media implemented in any methods or technology for storage of information, such as computer-readable instructions, computer-executable instructions, data structures, program modules, or other data. Examples of computer storage media can include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by a computer.

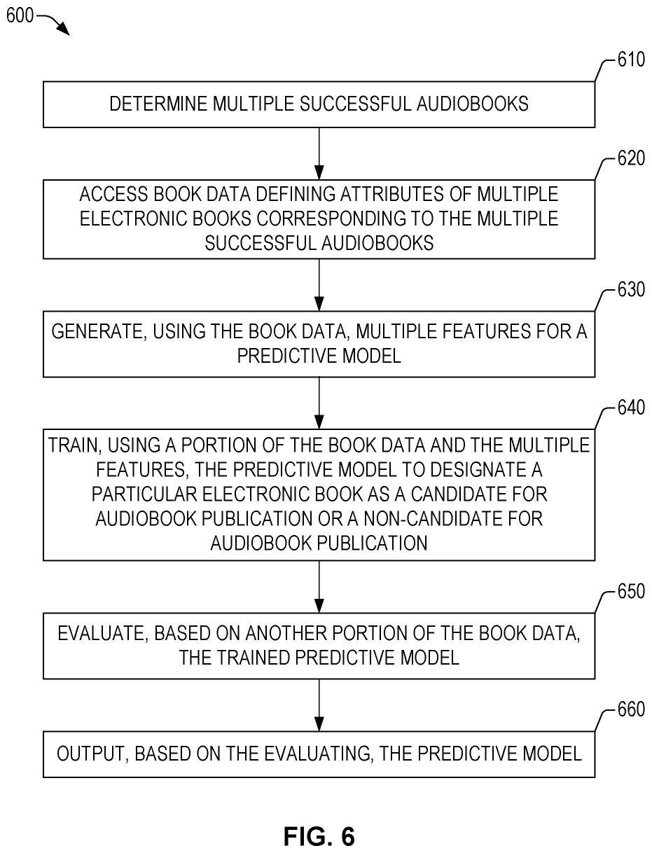

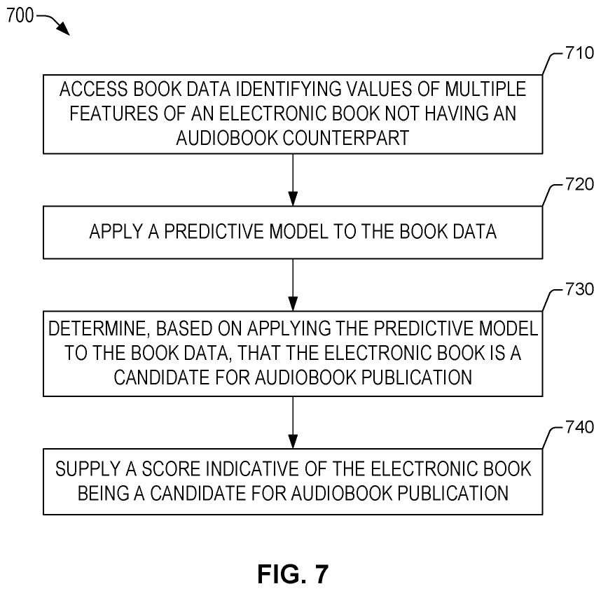

In view of the aspects described herein, example methods that may be implemented in accordance with the disclosure can be better appreciated with reference, for example, to the flowcharts in FIGS. 6-7. For the sake of simplicity of explanation, the example methods disclosed herein are presented and described as a series of blocks (with each block representing an action or an operation in a method, for example). However, the example methods are not limited by the order of blocks and associated actions or operations, as some blocks may occur in different orders and/or concurrently with other blocks from those that are shown and described herein. Further, not all illustrated blocks, and associated action(s), may be required to implement an example method in accordance with one or more aspects of the disclosure. Two or more of the example methods (and any other methods disclosed herein) may be implemented in combination with each other. It is noted that the example methods (and any other methods disclosed herein) may be alternatively represented as a series of interrelated states or events, such as in a state diagram.

FIG. 6 is a flowchart of an example computer-implemented method 600 for generating a predictive model for identification of an electronic book as a candidate for audiobook publication. A computing system can perform the example computer-implemented method 600 in its entirety or in part. To that end, the computing system includes computing resources that can implement at least one of the blocks included in the example computer-implemented method 600. The computing resources include, for example, central processing units (CPUs), graphics processing units (GPUs), tensor processing units (TPUs), memory, disk space, incoming bandwidth, and/or outgoing bandwidth, interface(s) (such as I/O interfaces or APIs, or both); controller devices(s): power supplies: a combination of the foregoing; and/or similar resources. For instance, the computing system can include programming interface(s): an operating system: software for configuration and or control of a virtualized environment: firmware; and similar resources.

At block 610, the computing system can determine multiple successful audiobooks. The multiple successful audiobooks can include a released audiobook having a number of sales equal to or greater than a threshold number over a defined time interval since release date of the released audiobook. To that end, the computing system can access first data identifying multiple audiobooks. Accessing the first data can include retrieving the first data from a third-party platform external to the computing system. The computing system can apply one or more filtering rules to first data to generate audiobook data identifying the multiple successful audiobooks. The third-party platform can be embodied in, or can include, the third-party source platform 210 (FIG. 2), for example. The third-party platform can retain one or more book-sales databases. The third-party platform can administer or otherwise control the book-sales database(s). The computing system can retrieve the first data from the book-sales database(s). In one configuration, while being external to the computing system, a third-party platform that hosts the book-sales databases can be co-located with the computing system. In another configuration, the third-party platform that hosts the book-sales databases can be remotely located relative to the computing system. In some cases, the book-sales databases can be integrated into the computing system and can be administered or otherwise controlled by an entity that administers the computing system. The computing system can then access the first data without reliance on the third-party platform.

At block 620, the computing system can access second data defining attributes of multiple electronic books corresponding to respective ones of the multiple successful audiobooks. The second data can be referred to as book data. The attributes can include static attributes and dynamic attributes. The static attributes can include, for example, title, author name, and genre, book length, story dynamics, character information (e.g., number or characters, type of characters), plot direction, a combination thereof, or similar attributes, for example. The dynamic attributes can include, for example, number of sales over a defined time period, sale revenue, sales trend, distribution trend, sale price point, and review rating, a combination thereof, or similar metrics. Accordingly, accessing the second data can include accessing values of the static attributes, and also accessing values of the dynamic attributes. Accessing the second data can include retrieving the second data from the third-party platform. For example, the computing system can retrieve the second data from at least one of the book-sales database(s).

At block 630, the computing system can generate, using the second data, multiple features for a predictive model. As mentioned, the predictive model can comprise one of a classification model or a regression model. Generating, using the second data, the multiple features can include selecting at least one of the static attributes or selecting at least one of the dynamic attributes. In some embodiments, generating, using the second data, the multiple features can include selecting a combination of the static attributes and the dynamic attributes. The computing system can select attributes by applying one or more selection techniques and/or one or more selection rules to the second data, as is described in connection with FIG. 4, for example.

At block 640 the computing system can train, using a portion of the second data and the multiple features, the predictive model to designate a particular electronic book as either a candidate for audiobook publication or a non-candidate for audiobook publication. In some embodiments, a classification model can be trained to solve a binary classification task. In one example, the task is to predict if an electronic book pertains to one of a candidate category and a non-candidate category. The candidate category can contain electronic books having a number of sales of audiobook counterparts that is equal to or greater than a threshold number during a defined time interval. The non-candidate second category is the complement of the candidate category. That is, the non-candidate category can contain electronic books having a number of sales of audiobook counterparts that is less than the threshold number during the defined time interval. In other embodiments, the predictive model can be a regression model trained to predict a number of units of an audiobook counterpart sold during a defined period after a release date. Examples of the defined period include 60 days, 90 days, six months, or similar.

Accordingly, training, using a portion of the second data and the multiple features, the predictive model can include generating a predictive attribute for an electronic book of the multiple electronic books. The predictive attribute can include a score. In some embodiments, the score represents a likelihood that an audiobook counterpart of the electronic book has sales equal to or greater than a threshold number during a defined time interval after a release date. In other embodiments, the score represents the number of units of an audiobook counterpart sold during the defined time interval after the release date.

At block 650, the computing system can evaluate, using another portion of the second data, the trained predictive model. That other portion of the second data serves as a testing data set, and the trained predictive model can be evaluated in accordance with aspects described herein.

At block 660, the computing system can output, based on the evaluating, the trained predictive model. Outputting the trained predictive model can include storing the predictive model in one or more memory devices, such as one or more non-volatile memory devices. The one or more memory device can embody, or can constitute, the data storage 160 (FIG. 1).

FIG. 7 is a flowchart of an example computer-implemented method 700 for evaluating an electronic book as a candidate for audiobook publication. A computing system can perform the example computer-implemented method 700 in its entirety or in part. To that end, the computing system includes computing resources that can implement at least one of the blocks included in the example computer-implemented method 700. The computing resources include, for example, CPUs, GPUs, TPUs, memory, disk space, incoming bandwidth, and/or outgoing bandwidth, interface(s) (such as I/O interfaces or APIs, or both); controller devices(s): power supplies: a combination of the foregoing; and/or similar resources. For instance, the computing system can include programming interface(s): an operating system: software for configuration and or control of a virtualized environment; firmware; and similar resources. The computing system that implements the example computer-implemented method 700 can be the same as the computing system that implements the example computer-implemented method 600, in some embodiments.

At block 710, the computing system can access book data identifying values of multiple features of an electronic book not having an audiobook counterpart. The multiple features can include static attributes of the electronic book and dynamic attributes of the electronic book. As mentioned, the static attributes can include title, author name, genre, book length, story dynamics, character information (e.g., number or characters, type of characters), plot direction, a combination thereof, or similar attributes, for example. As also mentioned, the dynamic attributes can include number of sales over a defined time period, sale revenue, price point, review rating, a combination thereof, or similar metrics, for example. In some embodiments, accessing the book data can include generating the book data based on source data obtained from a third-party platform (e.g., third-party source platform 210 (FIG. 2). The third-party platform can host one or more book-sales databases, in some embodiments. More specifically, accessing the book data can include generating values of the static attributes of the electronic book, and generating values of the dynamic attributes for the electronic book. The values of the static attributes and the values of the dynamic attributes constitute the book data.

At block 720, the computing system can apply the predictive model to the book data. In some embodiments, the predictive model can be a classification model trained to solve a binary classification task. In one example, the task is to predict if the electronic book pertains to one of a candidate category and a non-candidate category. The candidate category corresponds to electronic books having a number of sales of audiobook counterparts that is equal to or greater than a threshold number (e.g., 5000 audiobook units). The non-candidate second category is the complement of the candidate category. That is, the non-candidate category corresponds to electronic books having a number of sales of audiobook counterparts that is less than the threshold number. In other embodiments, the predictive model can be a regression model trained to predict a number of units an audiobook counterpart sold during a defined period after release. Examples of the defined period include 60 days, 90 days, six months, or similar.

Accordingly, by applying the predictive model to the book data, the computing system can generate a prediction attribute representing a prediction as to whether the electronic book is a candidate for audiobook publication. As such, at block 730, the computing system can determine, based on applying the predictive model to the book data, that the electronic book is a candidate for audiobook publication. Determining that electronic book is a candidate for audiobook publication can include generating a prediction attribute indicative of the electronic book being a candidate for audiobook publication.

As is described herein, the prediction attribute can include a score. At block 740, the computing system can supply a score indicative of the electronic book being a candidate for audiobook publication. Supplying the score can include, in some embodiments, causing a dashboard device to present a visual element representative of the score. The dashboard device can be one of the dashboard devices 170 (FIG. 1). The visual element can be presented via a display device integrated into the dashboard device or functionally coupled thereto. The dashboard device can direct the display device to present the visual element in a user interface during execution of an analytics software application, in response to receiving the score. In some cases, the dashboard device can a part of the computing system. In other cases, the dashboard device can be remotely located relative to computing system.

Although not illustrated in FIG. 7, in some embodiments, the example computer-implemented method 700 also can include training the predictive model.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow: plain meaning derived from grammatical organization or punctuation: the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A computer-implemented method comprising:
accessing book data defining values of attributes of multiple electronic books corresponding to multiple successful audiobooks;
generating, using the book data, multiple features for a predictive model;
training, using a portion of the second data and the multiple features, the predictive model to designate a particular electronic book as a candidate for audiobook publication or a non-candidate for audiobook publication;
evaluating, using a second portion of the second data, the trained predictive model; and
outputting, based on the evaluating, the trained predictive model.

2. The computer-implemented method of claim 1, further comprising,
accessing book data identifying values of the multiple features of an electronic book not having an audiobook counterpart;
applying the trained predictive model to the book data;
determining, based on the applying, that the electronic book is a candidate for audiobook publication.

3. The computer-implemented method of claim 1, wherein the accessing comprises,
retrieving first source data from a book-sales database, the first source data identifying multiple second electronic books;
selecting a subset of the multiple second electronic books by applying a group of rules to the first source data;
retrieving second source data identifying values of a group of performance metrics corresponding to the subset of the multiple second electronic books; and
determining the book data as a union of a portion of the first source data that corresponds to the subset of the multiple second audiobooks and the second source data.

4. The computer-implemented method of claim 1, wherein the attributes comprise static attributes and dynamic attributes, the static attributes comprising title, author name, and genre, and the dynamic attributes comprising number of sales over a defined time interval, sale revenue, price point, and review rating, and wherein the generating comprises selecting a group of the dynamic attributes by applying at least one selection rule to the book data.

5. The computer-implemented method of claim 4, wherein the multiple successful audiobooks comprise a released audiobook having a number of sales equal to or greater than a threshold number over a defined time interval since release date.

6. The computer-implemented method of claim 1, wherein the training comprises generating a score for an electronic book of the multiple electronic books, the score representing a probability that the electronic book yields a successful audiobook.

7. The computer-implement method of claim 1, wherein the outputting comprises storing the predictive model in a non-volatile memory device.

8. The computer-implemented method of claim 1, wherein the predictive model comprises one of classification model or a regression model.

9. A computer-implemented method comprising:
accessing book data identifying values of multiple features of an electronic book not having an audiobook counterpart, wherein the multiple features comprise static attributes of the electronic book and dynamic attributes of the electronic book;
applying a predictive model to the book data;
determining, based on the applying, that the electronic book is a candidate for audiobook publication.

10. The computer-implemented method of claim 9, further comprising supplying a score indicative of the electronic book being a candidate for audiobook publication.

11. The computer-implemented method of claim 10, wherein the supplying comprises causing a computing device to present a visual element representative of the score.

12. The computer-implemented method of claim 9, wherein the applying comprises generating, using the book data, a score representative of a probability of the electronic book yielding a successful audiobook.

13. The computer-implemented method of claim 12, wherein the determining comprises determining that score meets or exceeds a defined threshold value.

14. The computer-implemented method of claim 9, wherein the accessing the book data comprises,
generating values of the static attributes of the electronic book, the static attributes comprising title, author name, and genre; and
generating values of dynamic attributes for the electronic book, the dynamic attributes comprising number of sales over a defined time interval, sale revenue, price point, and review rating;
wherein the book data comprises the values of the static attributes and the values of the dynamic attributes.

15. The computer-implemented method of claim 9, further comprising training the predictive model, wherein the predictive model comprises one of a classification model or a regression model.

16. A computing system comprising:
at least one processor; and
at least one memory device having computer-executable instructions stored thereon that, in response to execution by the at least one processor, cause the computing system at least to:
access book data identifying values of multiple features of an electronic book not having an audiobook counterpart, wherein the multiple features comprise static attributes of the electronic book and dynamic attributes of the electronic book;
apply a predictive model to the book data;
determine, based on the applying, that the electronic book is a candidate for audiobook publication.

17. The computing system of claim 16, the at least one memory device having further computer-executable instructions stored thereon that, in response to execution by the at least one processor, further cause the computing system to supply a score indicative of the electronic book being a candidate for audiobook publication.

18. The computing system of claim 17, wherein supplying the score comprises causing a computing device to present a visual element representative of the score, the computing device being remotely located relative to the computing system.

19. The computing system of claim 16, wherein applying the predictive model to the book data comprises generating, using the book data, a score representative of a probability of the electronic book yielding a successful audiobook.

20. The computer-implemented method of claim 19, wherein determining that the electronic book is a candidate for audiobook publication comprises determining that score meets or exceeds a defined threshold value.
